(19) United States
(12) Patent Application Publication
(10) Pub. No.: US 2008/0182946 A1
(43) Pub. Date: Jul. 31, 2008

(54) Nanourea dispersions

(75) Inventors: Sebastian Dorr, Dusseldorf (DE); Harald Blum, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 12/011,549

(22) Filed: Jan. 28, 2008

(30) Foreign Application Priority Data
Jan. 31, 2007 (DE) 102007004769.1

(51) Int. Cl. C08G 71/02

(52) U.S. Cl. 525/452

(57) ABSTRACT

The invention provides dispersions of nanoureas in non-aqueous dispersing media, a process for preparing them and their use.

### CROSS-REFERENCE TO RELATED APPLICATION

This application claims priority under 35 U.S.C. §119 (a-d) to German application No. 10 2007 004 769.1, filed Jan. 31, 2007.

### FIELD OF THE INVENTION

The invention relates to dispersions of nanoureas in non-aqueous dispersing media, to a process for preparing them and to their use.

### BACKGROUND OF THE INVENTION

The preparation of aqueous dispersions comprising crosslinked nanoscale polyurea particles is described in WO-A 2005/063873. It involves introducing hydrophilic isocyanates into water in the presence of a catalyst, as a result of which crosslinking takes place within the dispersed particles through urea bonds. These particles are employed therein as additives for contact adhesives based on polychloroprene dispersions.

The nanourea dispersions are unsuitable for use in non-aqueous or non-water-compatible systems on account of their water content of 50% to 80% by weight. Typical drying methods, such as the direct distillative removal of the water, for example, lead to an insoluble solid which can no longer be mixed homogeneously into a dispersing medium and therefore can no longer be introduced stably. Since many applications, such as coating compositions, or adhesives, for example, exist on an organic solvent basis, and the systems are not water-compatible, it would be desirable to provide non-aqueous nanourea dispersions.

### SUMMARY OF THE INVENTION

An object of the present invention was therefore to provide nanourea dispersions and also a process for preparing them.

It has now been found that aqueous dispersions which comprise crosslinked nanourea particles can be redispersed into a different dispersing medium and that the mixture can be freed from water. This results in innovative dispersions of nanoureas.

The present invention accordingly provides a nanourea dispersion comprising crosslinked nanourea particles a) and at least one non-aqueous dispersing medium which has at least one, preferably two group(s) reactive towards isocyanate groups, the water fraction of the dispersion being 0% to 5% by weight.

Dispersions for the purposes of the present invention are compositions of matter which are composed of finely divided particles in a non-aqueous dispersing medium. A feature of these mixtures is that phase separation does not take place; instead, at room temperature, the particles are stably distributed in the dispersing medium. The particles here are composed of solids; the dispersing medium may be solid or liquid at room temperature.

The average particle diameters of the dispersed nanourea particles a) (determined by means for example of LCS measurements, measurement at 23° C., measuring instrument: Malvern Zetasizer 1000, Malvern Instr. Limited) have sizes of 5 to 3000 nm, preferably of 10 to 1500 nm and more preferably of 30 to 300 nm.

The water content of the inventive dispersion (determined by the Karl-Fischer method) is 0% to 5%, preferably 0.002% to 2%, more preferably 0.01% to 1% and very preferably 0.01% to 0.2% by weight.

The amount of nanourea particles a) in the inventive dispersion is between 0.1% and 50%, preferably 1% to 25% by weight.

The nanourea particles a) present in the nanourea dispersion of the invention are obtained by reacting hydrophilicized polyisocyanates i) in an aqueous medium to form an aqueous nanourea dispersion. The particles are intraparticulately crosslinked substantially through urea bonds. The uncrosslinked or precrosslinked particles form as a result of the dispersing of the hydrophilicized polyisocyanates i) in water. Subsequently a portion of the isocyanate groups present is broken down to the primary or secondary amine by means of an isocyanate-water reaction. By reaction with further isocyanate groups, these amino groups then form urea groups and so crosslink to nanourea particles present in aqueous dispersion. It is also possible for some of the isocyanate groups to be reacted with water or with other isocyanate-reactive species, such as primary or secondary amines and/or alcohols, for example, before or during the reaction with water.

As hydrophilicized polyisocyanates i) it is possible per se to use all of the NCO-containing compounds known to the person skilled in the art that have been nonionically or potentially ionically hydrophilicized. Where mixtures of different polyisocyanates i) are used, it is preferred for at least one polyisocyanate to contain a nonionically hydrophilicizing structural unit. With particular preference, polyisocyanates i) containing nonionically hydrophilicizing groups are used exclusively.

By ionically or potentially ionically hydrophilicizing compounds are meant all compounds which contain at least one isocyanate-reactive group and also at least one functionality, such as —COOY, —SO₃Y, —PO(OY)₂ (Y for example=H, NH₄⁺, metal cation), —NR₂, —NR₃⁺ (R═H, alkyl, aryl), which on interaction with aqueous media enters into a pH-dependent dissociation equilibrium and in that way may carry a negative, positive or neutral charge. Preferred isocyanate-reactive groups are hydroxyl or amino groups.

Suitable ionically or potentially ionically hydrophilicizing compounds are, for example, mono- and dihydroxycarboxylic acids, mono- and diaminocarboxylic acids, mono- and dihydroxysulphonic acids, mono- and diaminosulphonic acids and also mono- and dihydrophosphonic acids or mono- and diaminophosphonic acids and their salts such as dimethylolpropionic acid, dimethylolbutyric acid, hydroxypivalic acid, N-(2-aminoethyl)-β-alanine, 2-(2-amino-ethylamino)ethanesulphonic acid, ethylenediamine-propyl- or -butyl-sulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal salts and/or ammonium salts; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and also compounds which contain units which can be converted into cationic groups, examples being amine-based units, such as N-methyldiethanolamine as hydrophilic synthesis components. Additionally it is possible to use cyclohexylaminopropanesulphonic acid (CAPS) as in WO-A 01/88006, for example, as a compound.

Preferred ionic or potential ionic compounds are those which possess carboxyl or carboxylate and/or sulphonate groups and/or ammonium groups. Particularly preferred ionic compounds are those which contain carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Examples of suitable nonionically hydrophilicizing compounds are polyoxyalkylene ethers which contain at least one hydroxyl or amino group. These polyethers contain a fraction of 30% to 100% by weight of units derived from ethylene oxide.

Hydrophilic synthesis components for incorporating terminal hydrophilic chains containing ethylene oxide units are preferably compounds of the formula (I),

H—Y′—X—Y—R (I)

in which
R stands for a monovalent hydrocarbon radical having 1 to 12 carbon atoms, preferably an unsubstituted alkyl radical having 1 to 4 carbon atoms,
X stands for a polyalkylene oxide chain having 5 to 90, preferably 20 to 70, chain members which are composed to an extent of at least 40%, preferably at least 65%, of ethylene oxide units and which in addition to ethylene oxide units may be composed of propylene oxide, butylene oxide or styrene oxide units, the latter units being preferably propylene oxide units, and
Y′/Y stands for oxygen or else for —NR′—, with R′ corresponding in its definition to R or hydrogen.

Particular preference is given to the copolymers of ethylene oxide with propylene oxide that have an ethylene oxide mass fraction of greater than 50%, more preferably of 55% to 89%. In one preferred embodiment compounds are used which have a molecular weight of at least 400 g/mol, preferably of at least 500 g/mol and more preferably from 1200 to 4500 g/mol.

Particularly preferred are nonionically hydrophilicized polyisocyanates i) which contain on average 5 to 70, preferably 7 to 55, oxyethylene groups, preferably ethylene groups, per molecule.

The hydrophilicized polyisocyanates i) are based on the aliphatic, cycloaliphatic, araliphatic and aromatic polyisocyanates that are known per se to the person skilled in the art and that have more than one NCO group per molecule and an isocyanate content of 0.5 to 50%, preferably 3 to 30%, more preferably 5% to 25% by weight, or mixtures thereof.

Examples of suitable polyisocyanates are butylene diisocyanate, tetramethylene diisocyanate, cyclohexan-1,3- and 1,4-diisocyanate, hexamethylene diisocyanate (HDI), 1-isocyanato-3,3,5-trimethyl-5-isocyanatomethylcyclohexane (isophorone diisocyanate, IPDI), 2,4,4-trimethylhexamethylene diisocyanate, isocyanatomethyloctane 1,8-diisocyanate, methylenebis(4-isocyanatocyclohexane), tetramethylxylylene diisocyanate (TMXDI) or triisocyanatononane (TIN, 4-isocyanatomethyloctane 1,8-diisocyanate) and also mixtures thereof. Also suitable in principle are aromatic polyisocyanates such as 1,4-phenylene diisocyanate, 2,4- and/or 2,6-toluylene diisocyanate (TDI), diphenylmethane 2,4′- and/or 4,4′-diisocyanate (MDI), triphenylmethane-4,4′-diisocyanate or naphthylene 1,5-diisocyanate.

In addition to the abovementioned polyisocyanates it is also possible to use higher molecular mass derivatives having a uretdione, isocyanurate, urethane, allophanate, biuret, iminooxadiazinedione and/or oxadiazinetrione structure. Such derivatives are known in a manner known per se from the monomeric diisocyanates through the modifying reactions described in the prior art.

The hydrophilicized polyisocyanates i) are based preferably on polyisocyanates or polyisocyanate mixtures of the aforementioned kind containing exclusively aliphatically or cycloaliphatically attached isocyanate groups, or any desired mixtures thereof.

With particular preference the hydrophilicized polyisocyanates are based on hexamethylene diisocyanate, isophorone diisocyanate or the isomeric bis(4,4′-isocyanatocyclohexyl)methanes and also mixtures of the aforementioned diisocyanates. The polyisocyanates i) preferably contain at least 50% by weight of polyisocyanates based on hexamethylene diisocyanate.

The dispersing of the nanourea particles a) in water and reaction with water for preparing the aqueous dispersion take place preferably with commixing by means of an agitator mechanism or other kinds of commixing, such as by pumped circulation, static mixer, barbed mixer, nozzle jet disperser, rotor and stator, or under the influence of ultrasound.

In principle it is also possible, during or after the dispersing operation, for NCO groups to be modified with isocyanate-reactive compounds such as primary or secondary amines or (poly)alcohols. Examples are ethylenediamine, 1,3-propylenediamine, 1,6-hexamethylenediamine, isophoronediamine, 4,4′-diaminodicyclohexylmethane, hydrazine, 1,4-butanediol, 1,4-cyclohexanedimethanol, 1,6-hexanediol, trimethylolethane, trimethylolpropane, glycerol, N-methylethanolamine and N-methylisopropanolamine, 1-aminopropanol or diethanolamine.

The molecular ratio of NCO groups of the hydrophilicized polyisocyanate i) to water is preferably 1:100 to 1:5, more preferably 1:30 to 1:10.

In principle it is possible to incorporate the hydrophilicized polyisocyanate i) in one portion by dispersion into the water. Likewise possible is a continuous addition of the hydrophilicized polyisocyanate, for example over a time of 30 minutes to 20 hours. Preference is given to addition in portions, the number of portions being 2 to 50, preferably 3 to 20, more preferably 4 to 10, and the portions being able to be equal or else different in size.

The waiting time between the individual portions is typically 5 minutes to 12 hours, preferably 10 minutes to 8 hours, more preferably 30 minutes to 5 hours.

Likewise possible is a continuous addition of the hydrophilicized polyisocyanate i) spread over a time of 1 hour to 24 hours, preferably 2 hours to 15 hours.

For the preparation of urea particles the reactor temperature is 10 to 80° C., preferably 20 to 70° C. and more preferably 25 to 50° C.

Following the reaction of the hydrophilicized polyisocyanate i) with water the reactor is preferably evacuated at internal temperatures of 0° C. to 80° C., preferably 20° C. to 60° C. and more preferably 25° C. to 50° C. Evacuation is carried out down to an internal pressure of 1 to 900 mbar, preferably 10 to 800 mbar, more preferably 100 to 400 mbar. The duration of this degassing procedure, which follows the actual reaction, is 1 minute to 24 hours, preferably 10 minutes to 8 hours. Degassing is also possible through temperature increase without evacuation.

Preferably the aqueous nanourea dispersion is mixed simultaneously with the evacuation, by means of stirring, for example.

The aqueous dispersions are prepared preferably in the presence of catalysts.

Examples of the catalysts used to prepare the aqueous nanourea dispersions include tertiary amines, tin compounds, zinc compounds or bismuth compounds or basic salts.

Examples of suitable catalysts are iron(II) chloride, zinc chloride, tin salts, tetraalkyl-ammonium hydroxides, alkali metal hydroxides, alkali metal alkoxides, alkali metal salts of long-chain fatty acids having 10 to 20 carbon atoms and, if appropriate, pedant OH groups, lead octoate or tertiary amines such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- and N-ethylmorpholine, N,N′-dimorpholinodiethyl ether (DMDEE), N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, N-hydroxypropyl imidazole, 1-azabicyclo[2.2.0]octane, 1,4-diazabicyclo[2.2.2]octane (Dabco) or alkanolamine compounds, such as triethanolamine, triisopropanolamine, N-methyl- and N-ethyldiethanolamine, dimethylaminoethanol, 2-(N,N-dimethylaminoethoxy)ethanol or N-tris(dialkylaminoalkyl)hexahydrotriazines, e.g. N,N′,N-tris(dimethylaminopropyl)-s-hexahydrotriazine.

Preference is given to tertiary amines such as tributylamine, triethylamine, ethyldiisopropylamine or 1,4-diazabicyclo[2.2.2]octane. Preferred tin compounds are tin dioctoate, tin diethylhexoate, dibuthyltin dilaurate or dibutyldilauryltin mercaptide. Preference is additionally given to 2,3-dimethyl-3,4,5,6-tetrahydropyrimidine, tetramethylammonium hydroxide, sodium hydroxide, sodium methoxide or potassium isopropoxide.

Particularly preferred catalysts are triethylamine, ethyldiisopropylamine or 1,4-diazabicyclo[2.2.2]octane.

The catalysts are used in amounts of 0.01% to 8%, preferably of 0.05% to 5%, more preferably of 0.1% to 3%, by weight based on the overall solids content of the resulting dispersion.

The catalyst can be mixed with the hydrophilicized polyisocyanate i) or with the dispersing water, or can be added after the polyisocyanates i) have been dispersed in water. It is preferred to admix the catalyst to the dispersing water prior to the addition of the polyisocyanate i). It is also possible to divide the catalyst into portions and to add them at different points during the course of the reaction.

It is likewise possible to add solvents such as N-methylpyrrolidone, N-ethylpyrrolidone, methoxypropyl acetate, dimethyl sulphoxide, methoxypropyl acetate, acetone and/or methyl ethyl ketone to the hydrophilicized polyisocyanate i) prior to dispersing. After the end of the reaction and dispersing it is possible to remove volatile solvents such as acetone and/or methyl ethyl ketone by distillation. Preference is given to preparation without solvent or the use of acetone or methyl ethyl ketone, particular preference to preparation without solvent.

The non-aqueous dispersing medium present in the nanourea dispersions of the invention has at least one, preferably two, group(s) reactive towards isocyanate groups.

Examples of suitable non-aqueous dispersing media include diamines, polyamines, diols, polyols or compounds which contain not only alcohol groups and primary and/or secondary amino groups but also groups reactive towards isocyanate groups.

Examples of the non-aqueous dispersing media described are polyester polyols, polyacrylate polyols, polyurethane polyols, polycarbonate polyols, polyether polyols, polyester polyacrylate polyols, polyurethanepolyacrylatepolyols, polyurethane polyester polyols, polyurethane polyether polyols, polyurethane polycarbonate polyols or polyester polycarbonate polyols.

Preferred non-aqueous dispersing media are substances which can be mixed with aqueous nanourea dispersions and from whose mixture with the aqueous nanourea dispersion it is possible to remove the water, such as polyesterpolyols, polycarbonatepolyols, polyetherpolyols and short-chain polyols, for example.

Examples of suitable short-chain polyols are ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A, (2,2-bis(4-hydroxycyclohexyl)propane), trimethylolpropane, glycerol, pentaerythritol or neopentyl glycol hydroxypivalate. Preferred short-chain polyols are 1,4- or 1,3-butanediol, 1,6-hexanediol or trimethylolpropane.

Examples of suitable monofunctional alcohols are ethanol, n-butanol, n-propanol, ethylene glycol monobutyl ether (2-butoxyethanol), diethylene glycol monomethyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol, diacetone alcohol, benzyl alcohol, amyl alcohol, cyclohexanol, furfuryl alcohol, o-cresol, m-cresol, p-cresol, and phenol. Preferred monofunctional alcohols are ethylene glycol monobutyl ether, diacetone alcohol, amyl alcohol or cyclohexanol.

Examples of diamines or polyamines are 1,2-ethylenediamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentamethylenediamine, diethylenetriamine, triaminononane, 1,3- and 1,4-xylylenediamine, α,α,α′,α′-tetramethyl-1,3- and -1,4-xylylenediamine and 4,4-diaminodicyclohexylmethane or dimethylethylenediamine. Preferred are 1,2-ethylenediamine, 1,6-diaminohexane or isophoronediamine.

Likewise suitable are compounds which as well as a primary amino group also contain secondary amino groups or which as well as an amino group (primary or secondary) also contain OH groups. Examples of such compounds are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol or neopentanolamine. Preferred are diethanolamine, 3-amino-1-methylaminopropane or 3-aminopropanol.

Particularly preferred dispersing media B) are polyesterpolyols, such as, for example, the conventional polycondensates of diols and also, where appropriate, triols and tetraols and dicarboxylic and also, where appropriate, tricarboxylic and tetracarboxylic acids or hydroxycarboxylic acids or lactones. Instead of the free polycarboxylic acids it is also possible to use the corresponding polycarboxylic anhydrides or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycol, and also 1,2-propanediol, 1,3-propanediol, butane-1,3-diol, butane-1,4-diol, hexan-1,6-diol and isomers, neopentyl glycol or neopentyl glycol hydroxypivalate, with preference being given to hexane-1,6-diol and isomers, neopentyl glycol and neopenthyl glycol hydroxypivalate. Besides these it is also possible to use polyols such as trimethylolpropane, glycerol, erythritol, pentaerythritol, trimethylolbenzene or trishydroxyethyl isocyanurate. Dicarboxylic acids which can be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid. Another acid source which can be used are the corresponding anhydrides. Where the average functionality of the polyol for esterification is > than 2, it is also possible in addition to use monocarboxylic acids as well, such as benzoic acid and hexanecarboxylic acid. Preferred acids are aliphatic or aromatic acids of the aforementioned kind. Particularly preferred are adipic acid, isophthalic acid and, where appropriate, trimellitic acid. Hydroxycarboxylic acids, which can be used as well as reaction participants when a polyesterpolyol with terminal hydroxyl groups is being prepared are, for example, hydroxycaproic acid, hydroxybutyric acid, hydroxydecanoic acid, hydroxystearic acid and the like. Suitable lactones are caprolactone, butyrolactone and homologues. Caprolactone is preferred.

Particularly preferred polyesterpolyols are those based on adipic acid, phthalic acid, isophthalic acid and tetrahydrophthalic acid as the acid component and on ethylene glycol, diethylene glycol, triethylene glycol; 1,4- or 1,3-butanediol, 1,6-hexanediol and/or trimethylolpropane as the alcohol component.

Likewise preferred for use as non-aqueous dispersing medium are hydroxyl-containing polycarbonates, preferably polycarbonatediols, having number-average molecular weights Mₙ of 400 to 8000 g/mol, preferably 600 to 3000 g/mol. They are obtainable by reaction of carbonic acid derivatives, such as diphenyl carbonate, dimethyl carbonate or phosgene, with polyols, preferably diols. Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A and lactone-modified diols of the aforementioned kind in question. The diol component preferably contains 40% to 100% by weight of hexanediol, preference being given to 1,6-hexanediol and/or hexanediol derivatives. Such hexanediol derivatives are based on hexanediol and as well as terminal OH groups contain ester groups or ether groups. Derivatives of this kind are obtainable by reacting hexanediol with excess caprolactone or by etherifying hexanediol with itself to form the di- or trihexylene glycol. Instead of or in addition to pure polycarbonate diols it is also possible to use polyether-polycarbonatediols. Hydroxyl-containing carbonates are preferably of linear construction, but may also be readily obtained by the incorporation of polyfunctional components, especially low molecular weight polyols. Examples of those suitable for this purpose include glycerol, trimethylolpropane, hexane-1,2,6-triol, butane-1,2,4-triol, trimethylolpropane, trimethylolethane, pentaerythritol, quinitol, mannitol, sorbitol, methylglycoside or 1,3,4,6-dianhydrohexitols. Preferred polycarbonates are constructed from diphenyl carbonate and/or dimethyl carbonate and from 1,6-hexanediol, 1,4-butanediol and methyl-1,3-propanediol.

As non-aqueous dispersing medium it is also possible with preference to use polyetherpolyols. Examples of those suitable are the polytetramethylene glycol polyethers known per se in polyurethane chemistry, of the kind obtainable by polymerizing tetrahydrofuran by means of cationic ring opening. Likewise suitable polyetherpolyols are the conventional adducts of styrene oxide, ethylene oxide, propylene oxide, butylene oxides and/or epichlorohydrin with difunctional or polyfunctional starter molecules. Suitable starter molecules that can be used include all of the compounds known from the prior art, such as, for example, water, butyldiglycol, glycerol, diethylene glycol, trimethylolpropane, propylene glycol, sorbitol, ethylenediamine, triethanolamine, 1,4-butanediol. Particular preference is given to using polyetherpolyols constructed from ethylene oxide, propylene oxide and butylene oxide.

The present invention also provides a process for preparing the non-aqueous nanourea dispersions of the invention, characterized in that in a first step an aqueous nanourea dispersion comprising crosslinked nanourea particles a) is mixed with at least one non-aqueous dispersing medium which has at least two groups reactive towards isocyanate groups, and subsequently in a second step the water is removed, simultaneously with the mixing operation or subsequent to complete mixing.

The aqueous nanourea dispersion and the non-aqueous dispersing medium can be mixed in either order; one component can be added continuously, in portions or all at once to the other component. In one preferred variant of the process the non-aqueous dispersing medium and the aqueous nanourea dispersion are first mixed completely with one another and then the water is removed from the mixture.

In principle it is possible to remove the water at atmospheric pressure, subatmospheric pressure or superatmospheric pressure. In one particularly preferred variant of the process the water is removed by distillation, operating under reduced pressure and/or under elevated temperature.

Other techniques as well are possible for the separation of water, such as, for example, dewatering by membrane methods or the use of water-removing drying agents, such as silica gel or zeolites, for example. Also possible is the combination of different dewatering techniques, simultaneously or in succession. A further possibility is to separate off the water with the aid of additives, examples being the admixing of entrainers for the simplified distillative removal of water.

In the process of the invention the mixing of the aqueous nanourea dispersion with the non-aqueous dispersing medium takes place preferably by means of commixing by an agitator mechanism. Other kinds of commixing are also possible, such as by pumped circulation, static mixer, shaker, rotation of a vessel, barbed mixer, nozzle jet disperser, rotor and stator, or by the influence of ultrasound. Commixing takes place at temperatures between 0° C. and 150° C., preferably between 10° C. and 120° C. and more preferably between 20° C. and 100° C. Commixing is carried out at temperatures at which the dispersing medium is in liquid form.

In the case of the removal of the water by distillation, the operation takes place at temperatures between 20° C. and 200° C., preferably between 25° C. and 150° C. and more preferably between 40° C. and 100° C. If the water is removed under reduced pressure, the pressure that is set is generally between 1 and 900 mbar, preferably between 2 and 500 mbar, more preferably between 5 and 100 mbar. The traversal of temperature profiles and/or pressure profiles is also possible. Examples of suitable dewatering times are between 10 minutes and 24 hours, preferably between 30 minutes and 16 hours. During the removal of the water the mixture preferably continues being mixed, by means of stirring and/or pumped circulation, for example.

In one preferred variant of the process of the invention the liquid or melted non-aqueous dispersing medium is introduced into a stirring apparatus and, with intense stirring, the aqueous nanourea dispersion is added dropwise, with preferred metering times being one minute to 10 hours, preferably 10 minutes to 5 hours, and subsequently the system is stirred for one hour to 10 hours, after which the water is removed from the dispersion by distillation and the dispersion is dried with a reduction in pressure.

In the preparation of the non-aqueous nanourea dispersion of the invention it is also possible for cosolvents, defoamers, surface-active detergents and other auxiliaries and additives to be used. If volatile cosolvents are used they can be removed again from the non-aqueous nanourea dispersion of the invention, together for example with the removal of the water.

Examples of further additives include catalysts, stabilizers, light stabilizers, antioxidants, biocides, pigments and/or fillers. Their addition may be made before, during or after the preparation of the non-aqueous nanourea dispersion of the invention.

The non-aqueous nanourea dispersions of the invention can be used as they are in the form, for example, of an additive, binder, auxiliary or adjuvant.

The present invention accordingly also provides for the use of the non-aqueous nanourea dispersions of the invention for preparing additives, binders or auxiliaries or adjuvants.

The present invention additionally provides additives, binders or auxiliaries or adjuvants comprising the non-aqueous nanourea dispersions according to the invention.

### EXAMPLES

Chemicals

Bayhydur® VP LS 2336 (Bayer MaterialScience AG, Leverkusen, Del.):

Hydrophilicized polyisocyanate based on hexamethylene diisocyanate, solvent-free, viscosity about 6800 mPa s, isocyanate content about 16.2%, Bayer MaterialScience AG, Leverkusen, Del.

Impranil® DLN (Bayer MaterialScience AG, Leverkusen, Del.):

Anionically hydrophilicized, non-cross-branched, aliphatic polyesterpolyurethane dispersion in water with a solids content of about 40%) Bayer MaterialScience AG, Leverkusen, Del.

Bayhydur® VP LS 2240 (Bayer MaterialScience AG, Leverkusen, Del.):

Nonionically hydrophilicized, aqueous polyisocyanate dispersion containing blocked isocyanate groups, solids content about 35% in water/MPA/xylene (56:4.5:4.5).

Isofoam® 16 (Petrofer-Chemie, Hildesheim, Del.):

Defoamer

The other chemicals were acquired in the fine chemicals trade from Sigma-Aldrich GmbH, Taufkirchen, Del.

Storage test: Storing of a sample in a 1 litre polyethylene bottle. Visual inspection for formation of a precipitate.

The water determination took place by means of Karl-Fischer titration in accordance with DIN 51777 Part 1. If amines are present, buffering is carried out using benzoic acid.

Unless noted otherwise all percentages are by weight.

Unless noted otherwise all analytical measurements relate to temperatures of 23° C.

The reported viscosities were determined by means of rotational viscometry in accordance with DIN 53019 at 23° C. using a rotational viscometer from Anton Paar Germany GmbH, Ostfildern, Del.

NCO contents, unless expressly stated otherwise, were determined volumetrically in accordance with DIN-EN ISO 11909.

The reported particle sizes were determined by means of laser correlation spectroscopy (instrument: Malvern Zetasizer 1000, Malvern Instr. Limited).

The solids contents were determined by heating a weighed sample at 120° C. At constant weight, the sample was weighed again and the solids content calculated.

Monitoring for free NCO groups was carried out by means of IR spectroscopy (band at 2260 cm⁻¹).

### 1) Preparation of an Aqueous Nanourea Dispersion

A solution of 20.72 g of triethylamine in 4952 g of deionized water was admixed at 30° C. and with vigorous stirring with 820.20 g of Bayhydur® VP LS 2336 and then with 0.32 g of Isofoam® 16 and stirring was continued. After 3, 6 and 9 hours, a further 820.20 g of Bayhydur® VP LS 2336 were added each time, followed in each case by 0.32 g of Isofoam® 16, and afterwards stirring was continued at 30° C. for 4 hours more. After that stirring was continued for 3 hours under a reduced pressure of 200 mbar and at 30° C., and the resulting dispersion was dispensed.

The white aqueous dispersion obtained had the following properties:

Particle size (LCS): 83 nm

Viscosity (viscometer, 23° C.): <50 mPas

pH (23° C.): 8.33

### 2) Comparative Example

Preparation of a Non-Aqueous Dispersion from an Anionically Hydrophilicized, Non-Cross-Branched, Aliphatic Polyesterpolyurethane Dispersion (Dispersing Medium: 1,4-butanediol)

A stirring apparatus with top-mounted distillation unit is charged at room temperature with 500 g of 1,4-butanediol. 125 g of Impranil® DLN dispersion are added dropwise with stirring over the course of 30 minutes. Gel particles are formed in the mixture. Stirring is continued at room temperature for 5 hours. The system is then evacuated to about 100 mbar at 75° C. and the water is distilled off via the top-mounted distillation unit over approximately 3 hours. In the course of this procedure the pressure is reduced further down to 1 mbar. The result is a gelatinous, inhomogeneous mixture.

### 3) Comparative Example

Preparation of a Non-Aqueous Dispersion from a Nonionically Hydrophilicized, Non-Cross-Branched, Aliphatic Polyesterpolyurethane Dispersion (Dispersing Medium: 1,4-butanediol)

A stirring apparatus with top-mounted distillation unit is charged at room temperature with 500 g of 1,4-butanediol. Over the course of 40 minutes, 125 g of Bayhydur® VP LS 2240 dispersion are added dropwise with stirring to the dispersion. The system is then evacuated to about 100 mbar at 75° C. and the water is distilled off via the top-mounted distillation unit over approximately 3 hours. In the course of this procedure the pressure is reduced further down to 1 mbar. Lumps are formed which settle on the base of the vessel when the stirrer motor is switched off. A stable dispersion is not formed.

### 4) Comparative Example

Preparation of a Non-Aqueous Dispersion from an Aqueous Nanourea Dispersion from Example 1) by Drying of the Nanourea Dispersion and Subsequent Dispersing (Dispersing Medium: 1,4-butanediol, 10% by Weight Nanoparticles)

A stirring apparatus is charged at room temperature with 1 kg of the dispersion from Example 1) and evacuated to about 50 mbar with stirring. The temperature of the heating bath is gradually increased to 100° C. until water is no longer distilled over. Subsequently stirring is continued at about 10 mbar and at the same temperature for about 3 hours more.

50 g of the resulting white solid are taken and added to 450 g of 1,4-butanediol with vigorous stirring in a further stirring apparatus. Even after 2 hours of stirring at room temperature and a subsequent increase to 120° C., (3 hours) no uniform mixing is developed. After cooling and switching-off of the stirrer motor, the white solid settles.

### 5) Comparative Example

Preparation of a Non-Aqueous Dispersion from an Aqueous Nanourea Dispersion from Example 1) by Drying of the Nanourea Dispersion with Freeze Drying and Subsequent Dispersing (Dispersing Medium: 1,4-butanediol, 10% by Weight Nanoparticles)

The procedure described in Example 4 was repeated, but dispersion from Example 1) was frozen in a refrigerating bath in a 2-litre round-bottomed flask and mounted to a freeze-drying unit.

50 g of the resulting white solid are taken and added to 450 g of 1,4-butanediol with vigorous stirring in a further stirring apparatus. Even after 2 hours of stirring at room temperature and a subsequent increase to 120° C., (3 hours) no uniform mixing is developed. After cooling and switching-off of the stirrer motor, the white solid settles.

### 6) Inventive

Preparation of a Non-Aqueous Dispersion from Aqueous Nanourea Dispersion from Example 1) (Dispersing Medium: 1,4-butanediol, 9% by Weight Nanoparticles)

The procedure described in Example 2) is repeated but 128 g of the dispersion from Example 1 are added instead of Impranil® DLN.

The white, non-aqueous dispersion obtained had the following properties:

Particle size (LCS): 136 nm

Viscosity (viscometer, 23° C.): 137 mPas

Water content (Karl-Fischer): 0.076%

### 7) Inventive

Preparation of a Non-Aqueous Dispersion from Aqueous Nanourea Dispersion from Example 1) (Dispersing Medium: 1,4-butanediol, 20% by Weight Nanoparticles)

The procedure described in Example 2) is repeated but 320 g of the dispersion from Example 1 are added instead of Impranil® DLN.

The white, non-aqueous dispersion obtained had the following properties:

Particle size (LCS): 112 nm

Viscosity (viscometer, 23° C.): 310 mPas

Water content (Karl-Fischer): 0.046%

### 8) Inventive

Preparation of a Non-Aqueous Dispersion from Aqueous Nanourea Dispersion from Example 1) (Dispersing Medium: 1,4-butanediol, 29% by Weight Nanoparticles)

The procedure described in Example 2) is repeated but 400 g of 1,4-butanediol and 409 g of the dispersion from Example 1 are added instead of Impranil® DLN.

The white, non-aqueous dispersion obtained had the following properties:

Particle size (LCS): 136 nm

Viscosity (viscometer, 23° C.): 741 mPas

Water content (Karl-Fischer): 0.065%

### 9) Inventive

Preparation of a Non-Aqueous Dispersion from Aqueous Nanourea Dispersion from Example 1) (Dispersing Medium: polyester-polyol, 9% by Weight Nanoparticles)

A stirring apparatus with top-mounted distillation unit is charged with 1000 g of a polyester-diol based on adipic acid, ethylene glycol and 1,4-butanediol, (OH number 55 mg KOH, acid number max. 1 mg KOH) at 40° C. Over the course of 40 minutes 256 g of the dispersion from Example 1) are added dropwise with stirring. The system is then evacuated to about 100 mbar at 80° C. and the water is distilled off over about 3 hours via the distillation unit. In the course of this procedure the pressure is reduced further down to 1 mbar.

This gives a white, non-aqueous dispersion which solidifies on cooling to room temperature. The dispersion can be liquefied again by means of increased temperature.

Water content (Karl-Fischer): 0.04%

### 10) Inventive

Preparation of a Non-Aqueous Dispersion from Aqueous Nanourea Dispersion from Example 1) (Dispersing Medium: polyether-polyol, 9% by Weight Nanoparticles)

A stirring apparatus with top-mounted distillation unit is charged with 900 g of a polyether-polyol based on glycerol, polyethylene oxide and polypropylene oxide, (OH number: 35, average functionality: 3) at room temperature. Over the course of 70 minutes 230 g of the dispersion from Example 1) are added dropwise with stirring. Stirring is continued at room temperature for 5 hours. The system is then evacuated to about 100 mbar and the water is distilled off over about 3 hours via the distillation unit. Thereafter the reduced pressure is reduced down to about 1 mbar and dewatering takes place for a further 5 hours at a reactor temperature of about 50° C.

This gave a white, non-aqueous dispersion having the following properties:

Viscosity (Haake rotational viscometer, 23° C. 2100 mPas

Particle size (laser correlation spectroscopy, LCS) 647 nm

Water content (Karl-Fischer): 0.02%

### 11) Inventive

Preparation of a Non-Aqueous Dispersion from Aqueous Nanourea Dispersion from Example 1) (Dispersing Medium: isophoronediamine, 10% by Weight Nanoparticles)

The procedure described in Example 6) is repeated but with the addition of 500 g of isophoronediamine instead of 500 g of butanediol.

The white, non-aqueous dispersion obtained had the following properties:

Particle size (LCS): 91 nm

Viscosity (viscometer, 23° C.): <50 mPas

Water content (Karl-Fischer): 0.02%

### 12) Inventive

Preparation of a Non-Aqueous Dispersion from Aqueous Nanourea Dispersion from Example 1) (Dispersing Medium: hydroquinone bis(2-hydroxyethyl ether), 9% by Weight Nanoparticles)

A stirring apparatus with top-mounted distillation unit is charged with 300 g of hydroquinone bis(2-hydroxyethyl ether) at 100° C. Over the course of 40 minutes 77 g of the dispersion from Example 1) are added dropwise with stirring. The system is then evacuated to about 50 mbar at 100° C. and the water is distilled off over about 3 hours via the distillation unit. In the course of this procedure the temperature is gradually raised to 160° C.

This gives a non-aqueous dispersion which solidifies on cooling to room temperature. The dispersion can be liquefied again by means of increased temperature.

Water content (Karl-Fischer): 0.04%

### 13) Inventive

Preparation of a Non-Aqueous Dispersion from Aqueous Nanourea Dispersion from Example 1) (Dispersing Medium: 2-butoxyethanol, 9% by Weight Nanoparticles)

A stirring apparatus with top-mounted distillation unit is charged with 900 g of 2-butoxyethanol at 25° C. Over the course of 40 minutes 256 g of the dispersion from Example 1) are added dropwise with stirring. The system is then evacuated to about 30 mbar at 80° C. and the water is distilled off over about 15 hours via the distillation unit.

The white, non-aqueous dispersion obtained had the following properties:

Particle size (LCS): 93 nm

Viscosity (viscometer, 23° C.): <100 mPas

Water content (Karl-Fischer): 0.032%

1. Nanourea dispersion comprising crosslinked nanourea particles a) and at least one non-aqueous dispersing medium which has at least one group reactive towards isocyanate groups, the water fraction of the dispersion being 0% to 5% by weight.

2. Nanourea dispersion according to claim 1, wherein the nanourea particles a) are obtained by reacting hydrophilicized polyisocyanates i) in an aqueous medium.

3. Nanourea dispersion according to claim 2, wherein at least one polyisocyanate of the hydrophilicized polyisocyanates i) contains a nonionically hydrophilicizing structural unit.

4. Nanourea dispersion according to claim 2, wherein the hydrophilicized polyisocyanates i) are nonionically hydrophilicized polyisocyanates i) which contain on average 5 to 70 oxyethylene groups per molecule.

5. Nanourea dispersion according to claim 1, wherein the non-aqueous dispersing medium is selected from the group consisting of diamines, polyamine, diols, polyols or compounds which contain not only alcohol groups and primary and/or secondary amino groups but also groups reactive towards isocyanate groups.

6. Nanourea dispersion according to claim 1, wherein the dispersing medium is a polyester polyol, polycarbonate diol or polyether polyol.

7. Process for preparing the nanourea dispersion according to claim 1, the process comprising the steps of
1) mixing an aqueous nanourea dispersion comprising crosslinked nanoparticles a) with at least one non-aqueous dispersing medium which has at least one group reactive towards isocyanate groups, and
2) removing the water, either simultaneously with the mixing operation or subsequent to complete mixing.

8. Process according to claim 7, wherein the water is removed by distillation with a pressure reduction and/or temperature increase.

9. Process according to claim 7, wherein mixing continues during removal of the water.

10. Process according to claim 7, wherein the non-aqueous dispersing medium is introduced into a stirring apparatus and, with intense stirring, the aqueous nanourea dispersion is added dropwise, the metering time being one minute to 10 hours, and subsequently the system is stirred for one hour to 10 hours, then the water is removed from the dispersion by distillation and the dispersion is dried with a reduction in pressure.

11. Use of the nanourea dispersions according to claim 1 for preparing additives, binders or auxiliaries or adjuvants.

12. Additives, binders or auxiliaries or adjuvants comprising the nanourea dispersions according to claim 1.
